(19) United States
(12) Patent Application Publication
(10) Pub. No.: US 2015/0102762 A1
(43) Pub. Date: Apr. 16, 2015

(54) PORTABLE FOLDING PHOTOVOLTAIC SOLAR CHARGER

(71) Applicant: ASPECT SOLAR PTE LTD., Singapore (SG)

(72) Inventors: ESMOND GOEI, BROOMFIELD, CO (US); MOK TIONG TAN, SINGAPORE (SG); ANDREW GOEI, BROOMFIELD, CO (US); HARYADI MARNYO, SINGAPORE (SG); RYAN FLORES MEJIA, SINGAPORE (SG)

(21) Appl. No.: 14/513,567

(22) Filed: Oct. 14, 2014

Related U.S. Application Data
(60) Provisional application No. 61/977,338, filed on Apr. 9, 2014.
(60) Provisional application No. 61/890,921, filed on Oct. 15, 2013.

(51) Int. Cl. H02J 7/35; H02J 7/00

(52) U.S. Cl. CPC H02J 7/355; H02J 7/0052
USPC 320/101

(57) ABSTRACT

A portable, solar energy charger, comprises a plurality of panels. Each panel contains at least one solar cell for generating electrical energy responsive to solar energy. Each of the plurality of panels are interconnected to enable the plurality of panels to be folded on top of each other in a single stack in a closed configuration and to be unfolded to receive sunlight in an open configuration. A connector connects each of the plurality of panels to at least one other panel of the plurality of panels. The connector provides both a mechanical connection and an electrical connection between panels. The connector enables a first panel to be folded on top of a second panel and protect the at least one solar cells on the first panel and the second panel between the first panel and the second panel. A securing mechanism maintains the plurality of panels together in the closed configuration when the panels are folded on each other.

### CROSS-REFERENCE TO RELATED APPLICATIONS

This application claims benefit of U.S. Provisional Application No. 61/890,921, filed Oct. 15, 2013, entitled PORTABLE FOLDING PHOTOVOLTAIC (PV) SOLAR CHARGER, WHICH CONSIST OF 2 OR MORE PV PANELS, WHEREBY THE DEPLOYED CONFIGURATION AND ORIENTATION OF THE PANELS ARE FLEXIBLE ALONG EDGES SEPARATING THE PV (Atty. Dkt. No. ASPS-31934), and U.S. Provisional Application No. 61/977,338, filed Apr. 9, 2014, entitled PORTABLE MODULAR EXPANDABLE MULTI-CONFIGURATION PHOTO VOLTAIC (PV) SOLAR CHARGER AND ELECTRICITY STORAGE SYSTEM WITH MULTIPLE ELECTRICAL OUTPUTS FOR MULTIPLE ELECTRONIC APPLICATIONS AND LOADS (Atty. Dkt. No. ASPS-32150), the specifications of which are incorporated by reference herein in their entirety.

### TECHNICAL FIELD

The present invention relates to solar chargers, and more particularly, to portable folding solar chargers that may be configured between open and closed configurations.

### BACKGROUND

As the need for increased supplies of electrical energy to power the ever-increasing number of portable electronic devices has risen, there has been a corresponding increase in the need of new and unique electrical energy generation products for powering the electrical devices. The use of battery storage packs, electrical charging cords and other portable charging devices have been implemented to charge electrical and electronic devices. Another portable energy charging solution has been the use of various types of solar cells for generating electricity in locations where electrical power outlets may not be available. The problem with solar panels is often their size which requires a great deal of storage area that often makes them hard to transport and be easily used with portable electronic devices. Thus, there is a need for a solar cell charging apparatus that is both portable and configurable in a manner that will ease the use of solar cells in mobile applications of a device or in remote locations.

### SUMMARY

The present invention, as disclosed and described herein, comprises a portable, solar energy charger, including a plurality of panels. Each panel contains at least one solar cell for generating electrical energy responsive to solar energy. Each of the plurality of panels are interconnected to enable the plurality of panels to be folded on top of each other in a single stack in a closed configuration and to be unfolded to receive sunlight in an open configuration. A connector connects each of the plurality of panels to at least one other panel of the plurality of panels. The connector provides both a mechanical connection and an electrical connection between panels. The connector enables a first panel to be folded on top of a second panel and protect the at least one solar cells on the first panel and the second panel between the first panel and the second panel. A securing mechanism maintains the plurality of panels together in the closed configuration when the panels are folded on each other.

### BRIEF DESCRIPTION OF THE DRAWINGS

For a more complete understanding, reference is now made to the following description taken in conjunction with the accompanying Drawings in which:

FIG. 1 illustrates a first embodiment of a portable folding photovoltaic charging panel;

FIG. 2 illustrates the embodiment of FIG. 1 for a first side of the panels in a closed configuration;

FIG. 3 illustrates a second side of the embodiment of FIG. 1 in the closed configuration;

FIG. 4 illustrates a first open configuration of the embodiment of FIG. 1;

FIG. 5 illustrates a second open configuration of the embodiment of FIG. 1;

FIG. 6 is a block diagram of the electrical configuration of the embodiment of FIG. 1;

FIGS. 7-9 illustrate a second embodiment of a portable folding photovoltaic charger;

FIG. 10 is a block diagram of the electrical circuit associated with the charger of FIGS. 7-9;

FIG. 11 illustrates a front side view of a further embodiment of a photovoltaic panel charger;

FIG. 12 illustrates a backside view of the embodiment of FIG. 11;

FIG. 13 illustrates the embodiment of FIG. 11 in a closed configuration;

FIG. 14 illustrates the embodiment of FIG. 11 in a closed and fastened mode;

FIG. 15 illustrates the positioning of zipper sliders for establishing configurations of the embodiment of FIG. 11;

FIG. 16 illustrates the embodiment of FIG. 11 in a first open configuration;

FIG. 17 illustrates the embodiment of FIG. 11 in a second open configuration;

FIG. 18 is a block diagram of the electrical circuit of the embodiment of FIG. 11;

FIGS. 19A-19C illustrate various configurations of a voltage regulator for the embodiment of FIG. 11;

FIG. 20 illustrates an alternative embodiment for interconnecting primary and secondary panels of the embodiment of FIG. 11;

FIG. 21 illustrates multiple quad modules interconnected with a docking station; and

FIG. 22 illustrates manners for increasing the number of panels connected to the primary panels in the embodiment of FIG. 11.

### DETAILED DESCRIPTION

Referring now to the drawings, wherein like reference numbers are used herein to designate like elements throughout, the various views and embodiments of portable folding photovoltaic solar charger are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

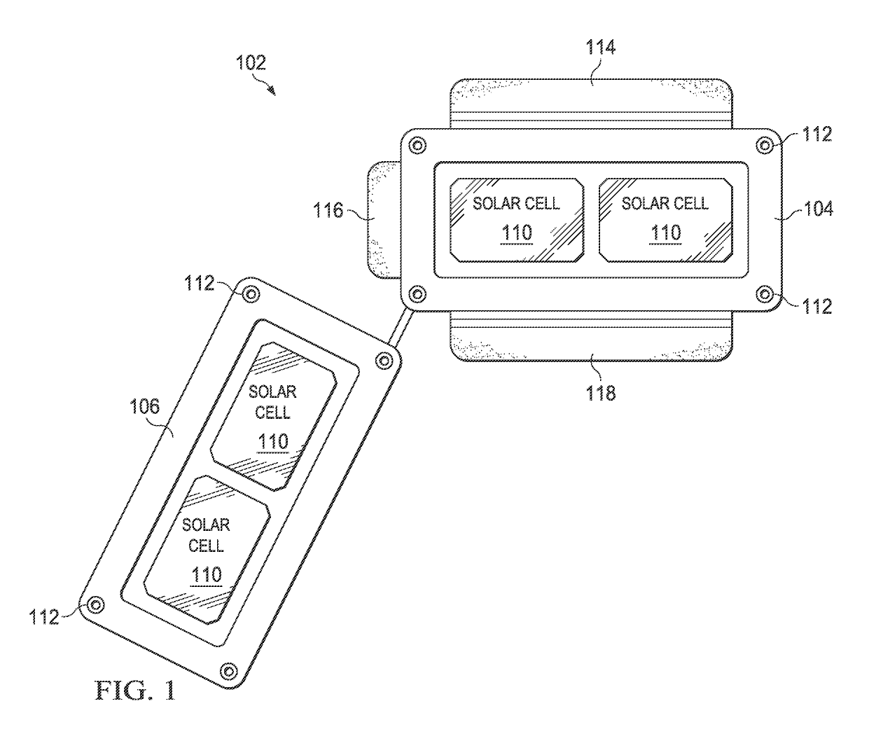

Referring now to the drawings, and more particularly to FIG. 1, there is illustrated a first embodiment of portable folding photovoltaic charging panels 102. The embodiment of FIG. 1 includes a first photovoltaic panel 104 and a second photovoltaic panel 106 that are interconnected via a flexible cable 108. Each of the panels 104 and 106 include a pair of solar cell 110 on one side thereof for receiving solar energy and converting it into electrical energy. Located at each corner of both of the photovoltaic panels 104 and 106 are eyelets 112. The eyelet 112 may be used for securing the photovoltaic panels 104 and 106 to prevent the panels from moving in wind or securing the panel to a surface during solar charging. The cable 108 is the electrical connection that connects the solar cells 110 on panel 104 with the solar cells 110 on panel 106.

Panel 104 additionally include three flexible flaps 114, 116 and 118 that are located along three edges of the charging panel 104 and are secured to the back of panel 104. The flaps 114, 116 and 118 are made of a flexible material that enables the flaps to be folded over and secured to a backside of the panel 106. The flaps 114, 116 and 118 will include some type of securing mechanism for securing it to the backside of panel 106. The securing mechanism may comprise Velcro, zippers, buttons, snaps or any other type of means for securing the flap 114, 116, 118 to the backside of panel 106.

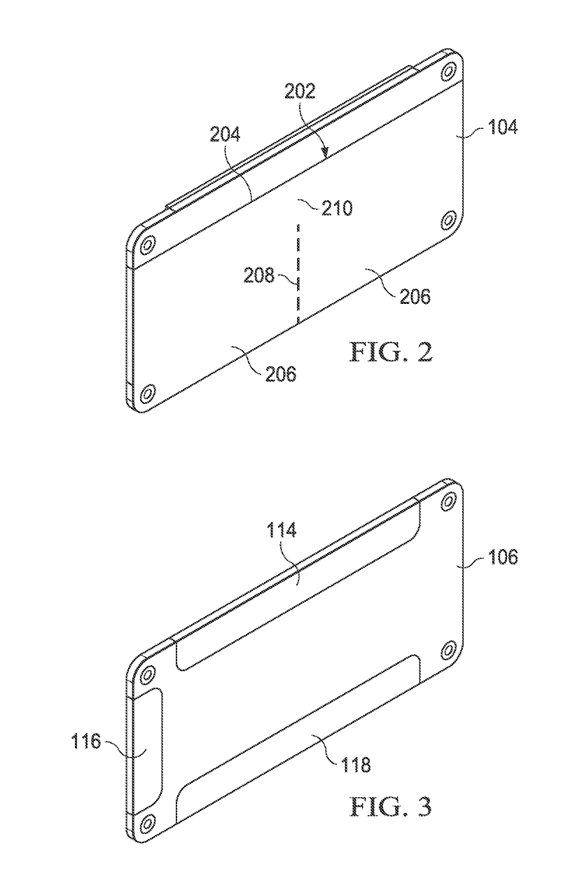

While FIG. 1 illustrates the portable, folding photovoltaic panels in an unfolded or open configuration, the panels 104 and 106 may also be placed in a folded or closed configuration as more particularly illustrated in FIGS. 2 and 3. FIG. 2 illustrates the backside of photovoltaic panel 104 and FIG. 3 illustrates the backside of photovoltaic panel 106. In each of FIGS. 2 and 3, the photovoltaic panels 104 and 106 are stacked one over the other with the solar cells 110 located on the inside of the stack. The panels 104 and 106 are held together by folding over flaps 114, 116 and 118 of panel 104 onto the back of panel 106 and secured the flaps onto panel 106 using Velcro, buttons, zippers, snaps or other appropriate connection means.

The material used to encase the backside of panels 104 and 106 may in one example comprise a water resistant polyester fabric which protects the panels from moisture and other exterior issues. The backside of panel 104 illustrated in FIG. 2 may also be configured to include an external pocket 202 that may be accessed via a pocket opening 204 that is secured using Velcro, zippers, buttons, snaps or other types of securing means. The external pocket 202 may be used for storing electronic devices such as mobile telephones, tablets, portable batteries, etc. The external pocket 202 may further consist of two or more compartments 206 that are separated via a seam 208 that is within the external pockets 202. While the illustration of FIG. 2 illustrates two compartments 206 separated by a single seam 208, it will be appreciated that any number of pockets may be utilized to configure the space within the internal pocket 202. An opening 210 between the compartments 206 enables a charger cable to pass between the compartments 206 so that electronic devices can be connected while inside the external pocket 202 without knocking against each other during transportation while still being protected from environmental conditions by keeping the external pocket zipper closed on pocket opening 204.

Referring now also to FIG. 3, there is illustrated the backside view of the photovoltaic panel 106. In this case, the flexible flaps 114, 116 and 118 that are connected to the photovoltaic panel 104 fold over the edges of photovoltaic panels 104 and 106 and secure to the backside of photovoltaic panel 106 using some type of securing means as described herein. In this manner, photovoltaic panels 104, 106 are held securely together with the solar cells on the inside of the stack to protect the cells.

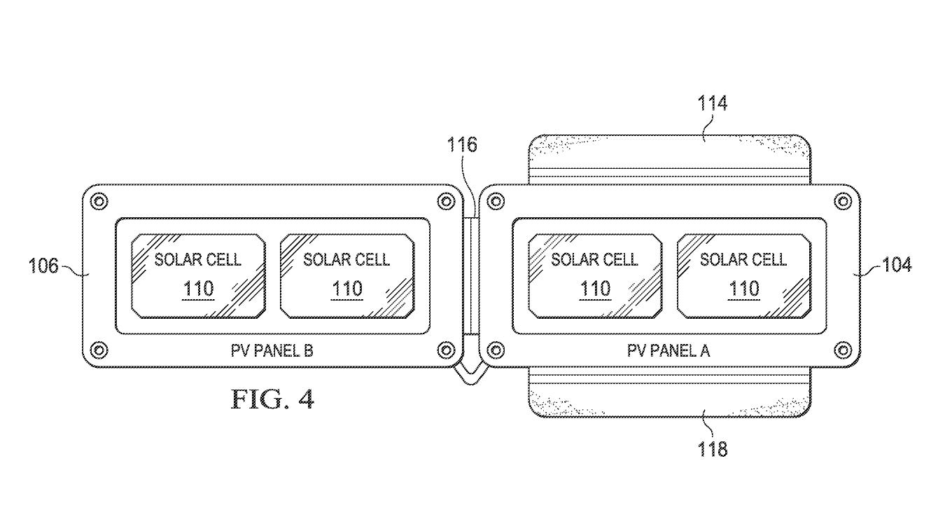

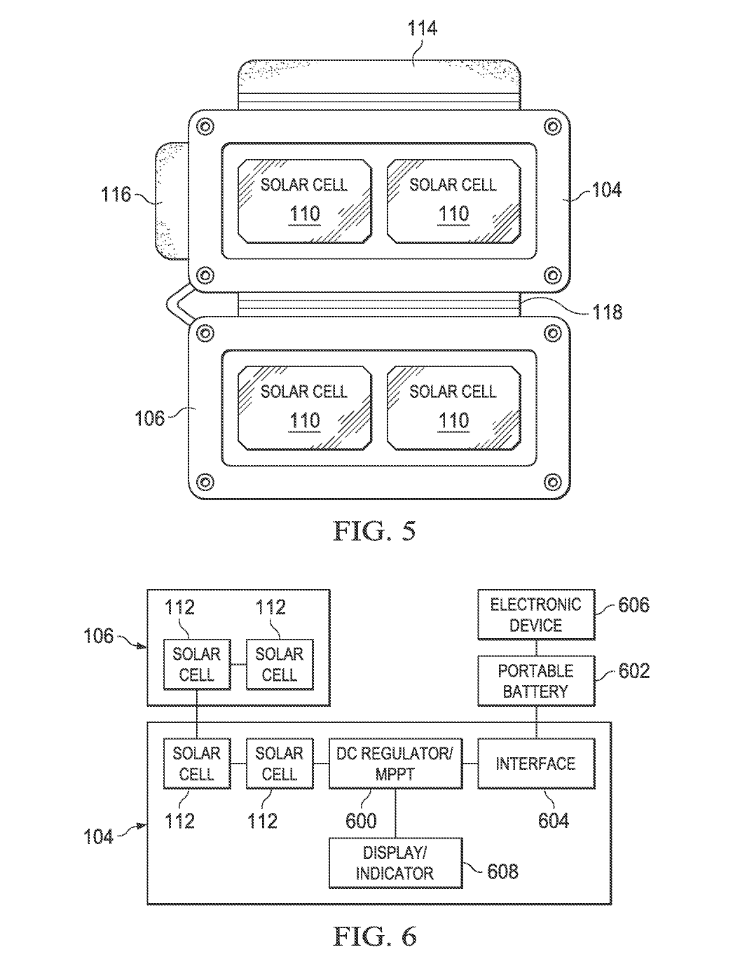

By selectively using the flaps 114, 116 and 118, the pair of photovoltaic panels 104, 106 may be placed in a long configuration as illustrated in FIG. 4 or a short configuration as illustrated in FIG. 5. Referring now to FIG. 4, in order to deploy the photovoltaic panels 104, 106 such that the panels lie along their long edges (“long configuration”), flap 114 and flap 118 are disconnected from the backside of photovoltaic panel 106 while flap 116 remains connected to the back of panel 106. The panels 104 and 106 are opened along the panel edge connected to flap 116 to provide the long configuration. Flap 116 is made of a flexible material such as polyester so that the panel is flexible and able to follow the shape of a supporting surface such as a backpack or dashboard of a car. In order to deploy the photovoltaic panels 104 and 106 such that they align along the short edges (“short configuration”) as illustrated in FIG. 5, flap 114 and flap 116 are disengaged from the back of photovoltaic panel 106. Panel 106 is opened from panel 104 along flexible flap 118 that remains connected to both of panels 104 and 106 to provide the short configuration. As mentioned previously, the eyelets 112 located at the corners of the panels 104 and 106 may be used for hanging the panels in either of the configurations illustrated in FIGS. 4 and 5.

Referring now to FIG. 6, there is illustrated a block diagram of the electrical configuration of the portable folding photovoltaic charging panels. The solar cells 112 within the panels 106 and 104 are interconnected in either a parallel or serial connection. The configuration of FIG. 6 illustrates the solar cells 112 interconnected in a serial connection. The output of the solar cells 112 is connected to a DC regulator or maximum power point tracking circuit 600. The DC regulator 600 is used to regulate the output voltage provided from the solar cells 112 to match the input of a removable portable battery 602. The DC regulator/maximum power point tracking circuit 600 interconnects with the portable battery 602 through an interface 604. The interface 604 may comprise any number of connection interfaces such as a micro USB, mini USB, DC jack, etc. When the circuit 600 comprises a DC regulator, the regulated voltage necessary for operating the portable battery 602 is provided through the interface 604. In order to improve the efficiency of the system a maximum power point tracking (MPPT) circuit 600 may be used to replace the DC regulator or may be incorporated into the charging circuit of the portable battery 602.

In order to ensure that the photovoltaic panels 106 and 104 are always oriented to get as much sunshine as possible, a display/indicator 608 can be coupled to the MPPT circuitry 600 to show the PV panel power output such that the user can place the photovoltaic panels 106 and 104 in an optimal sun-gathering direction. The display/indicator may comprise, for example, an LED/LCD display or other type of indicators that provide a visual indication of the solar energy collection. An electronic device 606 may be interconnected with the portable battery 602 to provide electrical energy to the electronic device from the portable battery that has been charged by the panels 106 and 104.

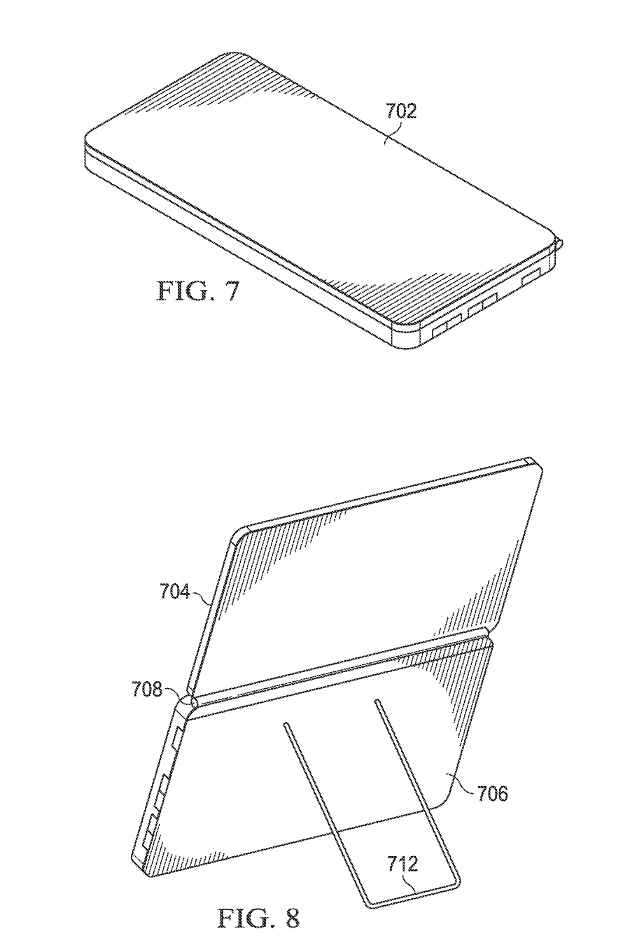

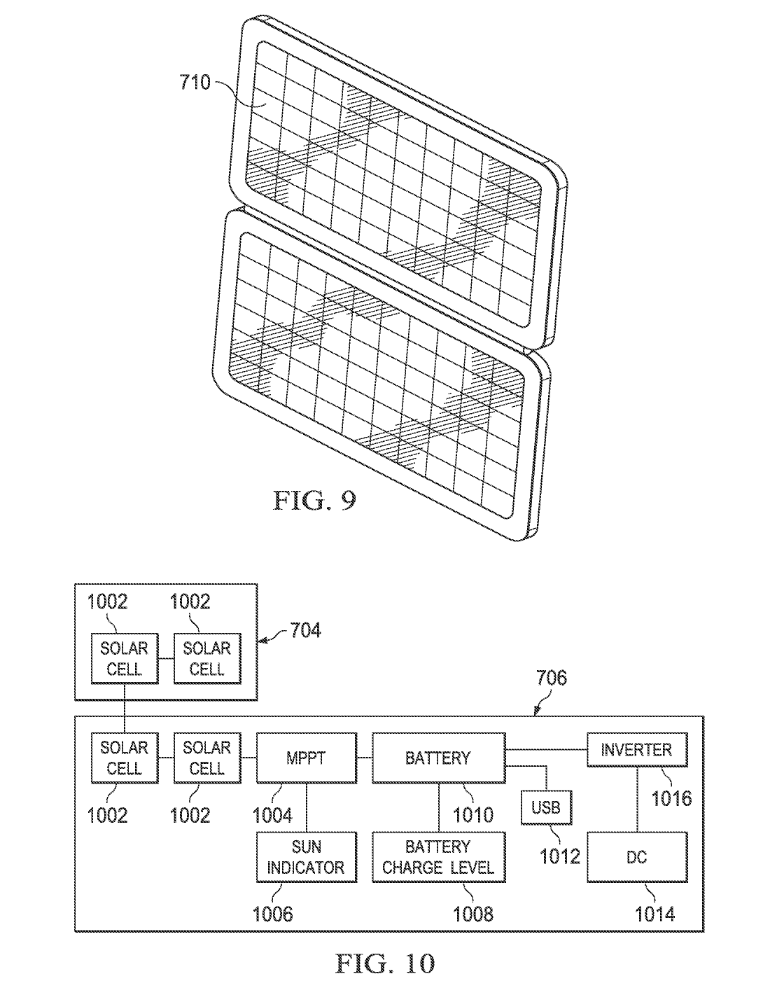

Referring now to FIGS. 7, 8 and 9, there is illustrated an alternative embodiment of a portable folding photovoltaic charger 702. In this configuration, the two photovoltaic panels 704 and 706 are interconnected along a single hinged edge 708. Each panel 704, 706 includes two or more solar cells on their interior face 710. The exterior surfaces of the panels 704 and 706 are encased in molded plastic. The electronics and user interface are built into the plastic case halves. The panels 704 and 706 are hinged along edge 708 so that they can be closed, causing the solar cells on interior faces 710 to face one another for transportation. The panels 704, 706 are opened for deployment to face the sun to generate electricity for charging an internal battery that is contained within the molded plastic case. On deployment, the panels 704, 706 can be set along a common plane and propped up on a retractable leg 712 which in the embodiment illustrated in FIG. 8 comprises a metal bar. However, it would be appreciated that the retractable leg 712 may comprise any type of member which may support the panels 704, 706 in an upright position.

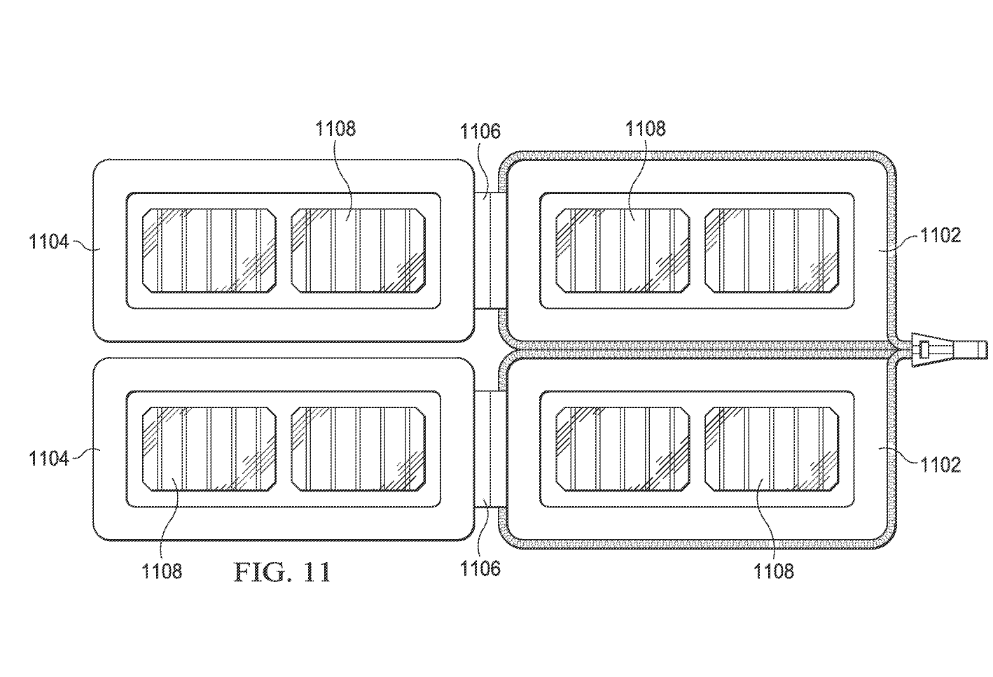

Referring now to FIG. 10 there is illustrated a block diagram of the electrical circuit associated with the portable folding charger of FIGS. 7-9. The solar cells 1002 are interconnected with each other in either a serial or parallel configuration. The solar cells 1002 provide the electrical energy to a maximum power point tracking circuit 1004. As part of the user interface of the system, a sun indicator circuit 1006, comprising for example an LED, is coupled to the MPPT 1004 as an energy indicator to detect optimal light gathering positions. Additionally, a battery charge level indicator 1008 is coupled to the battery 1010 that is charged via the power provided from the MPPT 1004. The battery charge level indicator 1008 provides an indication of the present charge level of the battery 1010 that is being charged through the MPPT 1004. One or more high power USB ports 1012 are provided for providing USB charging from the battery 1010. An DC power port 1014 connected to the battery 1010 through an inverter 1016 provides an DC electricity output from the panel 706 and 704.

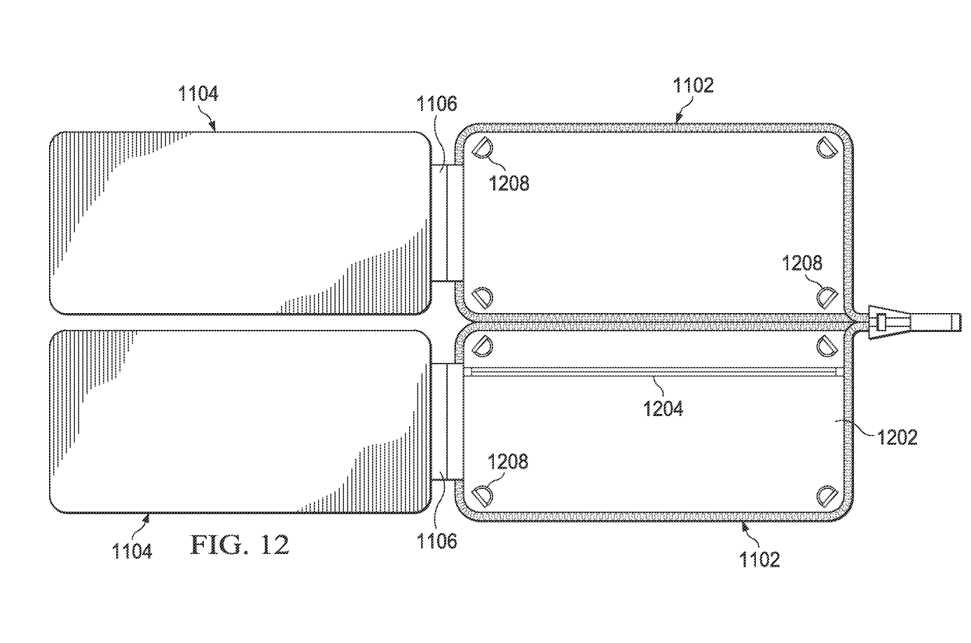

Referring now to FIGS. 11 and 12, there are illustrated a front side view (FIG. 11) and a backside view (FIG. 12) of a further embodiment of a group of four photovoltaic panels interconnected in a quad configuration (quad module). The four photovoltaic panels consist of primary panels 1102 and secondary panels 1104 connected via a flexible flap 1106. Each of the primary panels 1102 and secondary panels 1104 contain two solar cells 1108 thereon to provide a total of eight solar cells within the foldable and portable charger. The primary panels 1102 are electrically interconnected with each other via concealed wires. The primary panels 1102 are also electrically interconnected with a secondary panel 1104 via concealed wires.

The primary panels 1102 and secondary panels 1104 are encased within a water-resistant material. The water-resistant material may comprise a water-resistant polyester coated fabric although other materials such as molded rubber may also be utilized. The use of polyester coated fabric allows the primary panels to be equipped with pockets 1202 to house the charger's output cables/connector, battery and other electronic devices that are being charged. The pockets 1202 have an opening 1204 that may be closed via a zipper, snap, Velcro or other type of securing means. The securing means ensures that the electronic devices housed within the pocket 1202 are not exposed to the elements when the opening is completely closed. The polyester fabric on which the primary panels 1102 are mounted may further include D-rings 1208 in each of the corners to allow the use of carabiners or other hooking or fastening devices for hanging the solar charger during charging or for tying the solar charger down under windy conditions.

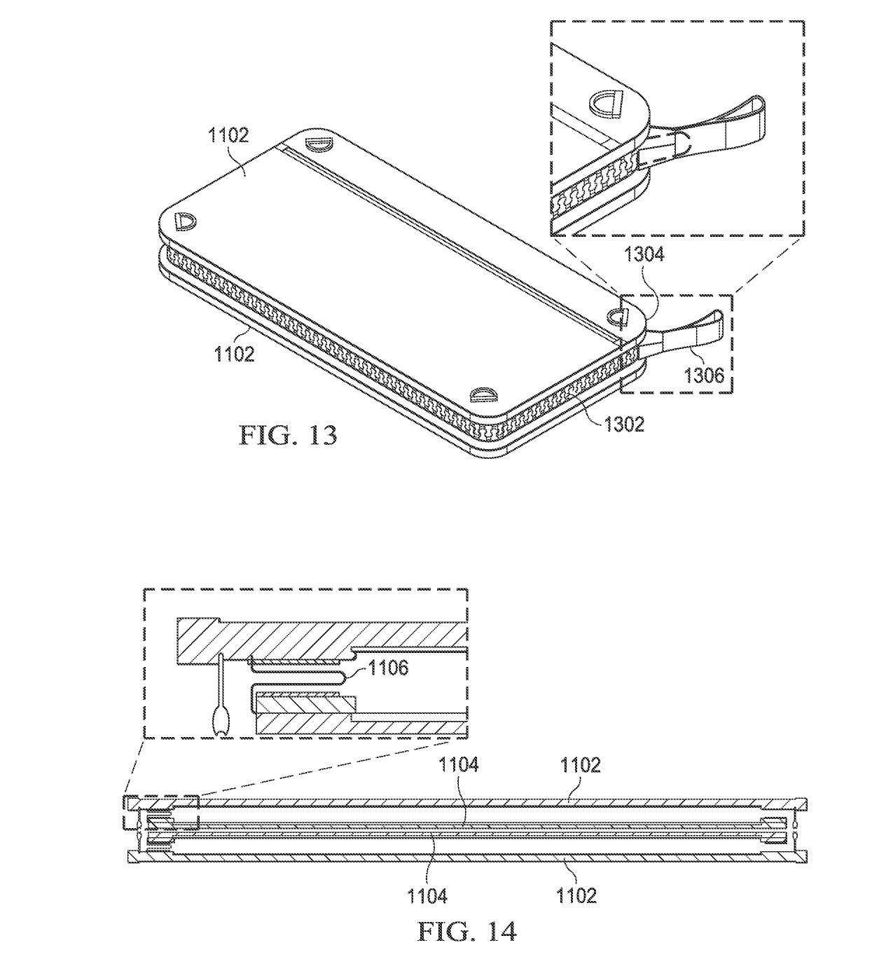

Referring now to FIG. 13, there is illustrated a view of the solar charger of FIG. 11 in a closed mode wherein all of the photovoltaic panels are stacked on top of each other. The two secondary panels 1104 are sandwiched in between the two primary panels 1102. Each primary panel 1102 and secondary panel 1104 pairing are electrically and mechanically interconnected via a flexible conduit flap 1306 as described previously which contains and conceals the connecting wiring. When closed, the periphery of both primary panels 1102 are attached to each together by a common zipper 1302 that goes around the periphery when the secondary panels 1104 are sandwiched between the primary panels 1102. The zipper 1302 joins all four edges of both the primary panel 1102 together, ending at the corner 1304 where the zipper line begins. The open end of both the beginning and ending line of the zipper 1302 may be linked by a strap 1306 made of leather, plastic or other material, thereby forming a closed loop with the zipper line to form a carrying handle.

The strap 1306 may also be used to conceal the electrical connection between the two panel pairs which may be electrically interconnected either in series or in parallel to produce different voltage and current outputs. The strap 1306 may also be replaced by a differently shaped carrying mechanism such as an ergonomically-fashioned (bulb) that fits in the hollow of the users hand and which bulb may house the connecting cable between panel pairs, and/or an LED or other mechanism to indicate the power state of the quad's solar cells or other electronics.

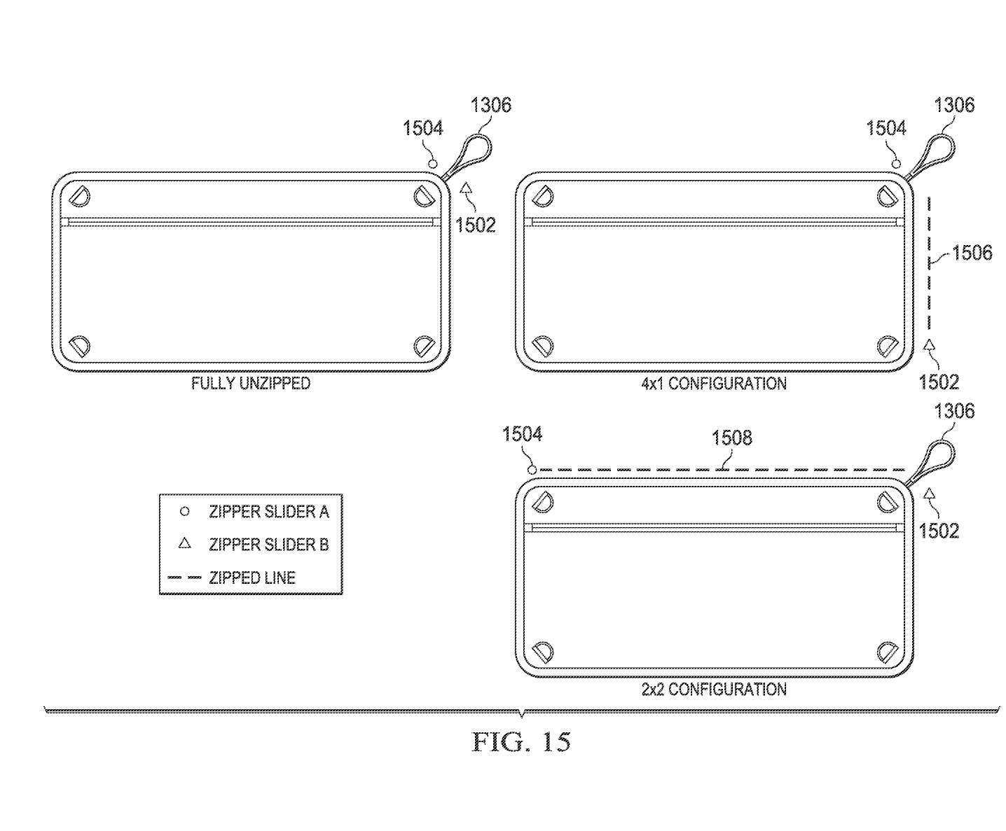

Referring now to FIG. 14, in the closed mode, the primary panels 1102 surround and protect the secondary panels 1104 in a sandwiched configuration. The primary panels 1102 are interconnected via the flexible tab 1106 which flexibly folds between the primary panels 1102 in the closed configuration. In the open mode, the zipper 1302 is unfastened such that only one of the edges of the primary panels remain attached to one another and both the primary panels 1102 are laid out with their solar cells 1108 facing up. The portable solar charger of FIG. 11 can be formed into a 4×1 configuration or a 2×2 configuration by positioning the zipper sliders 1502 and 1504 in the specific positions indicated in FIG. 15. In the fully unzipped configuration, the zipper sliders 1502 and 1504 are each located next to the strap 1306 and the primary panel 1102 have no edges that are connected.

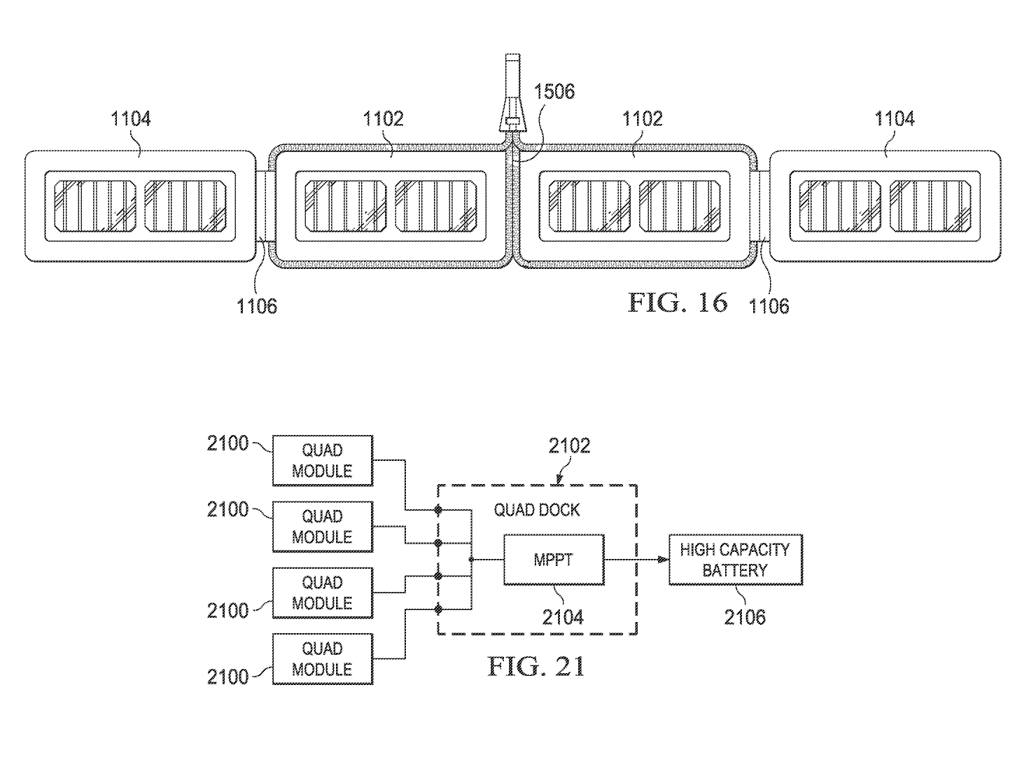

In the 4×1 configuration, a long edge of the primary panels remain attached to each other by closing the zipper 1502 along the length of the adjacent edge 1506 of the primary panels 1102. This allows the primary panels 1102 to open in the manner illustrated in FIG. 16. In this configuration, the primary panels 1102 are interconnected along edge 1506 and the secondary panels 1104 each extend outwardly from the primary panels 1102 from flexible flap 1106.

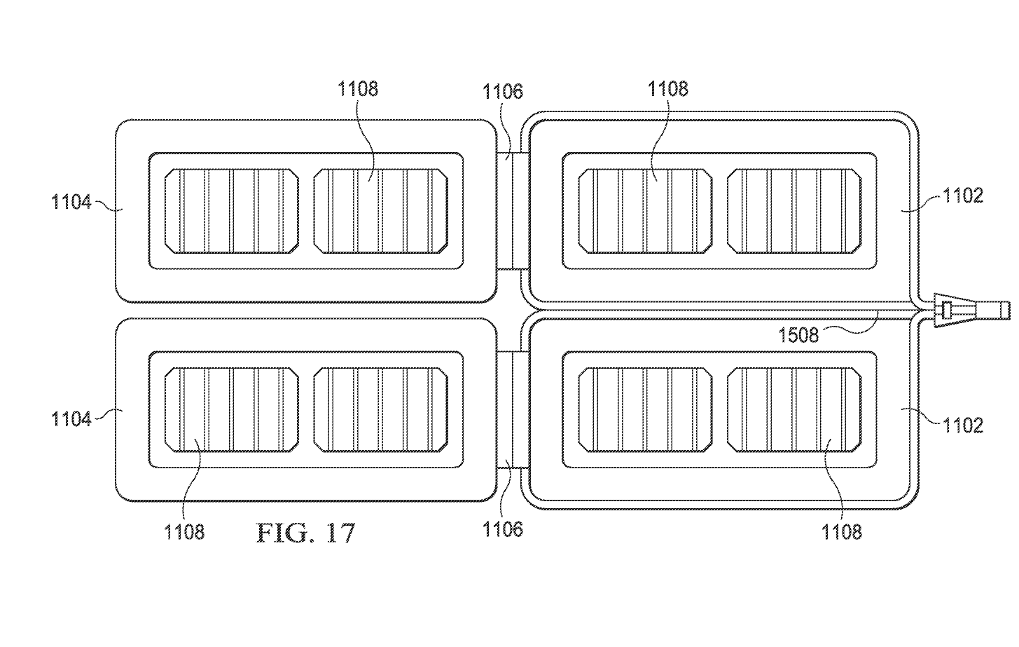

Similarly, the charger may be placed in a 2×2 configuration by closing the zipper 1504 along edge 1508. This allows the panels to be located in the configuration illustrated in FIG. 17. The primary panels 1102 are connected along edge 1508 and the secondary panels 1104 then extend outward from the primary panel 1102.

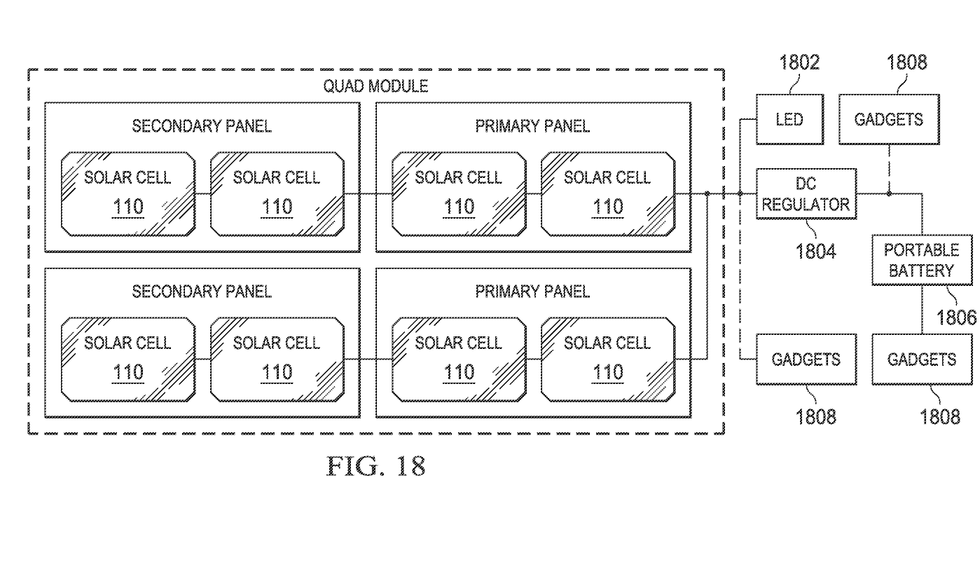

Referring now to FIG. 18, there is illustrated a block diagram of a basic electrical connection scheme of the quad module whereby the panel interconnections are set during manufacture of the quad module and each primary panel 1102 is interconnected to its respective secondary panel 1104 in series. In addition, the two panel pairs are permanently electrically hardwired, either in series or in parallel, at the time of manufacture. The output of the solar panel pairs is an unregulated DC output which may be connected to an LED 1802 as a solar cell power indicator and/or to a DC regulator 1804 to regulate the output voltage and provide the regulated output voltage as a charging voltage to a portable battery 1806. The output of the solar cell 1108, the DC regulator 1804 and the portable battery 1806 may each be connected to various electronics/gadgets 1808. The DC regulator 1804 may be designed for various output voltages as typically either a 5-volt or 12-volt output.

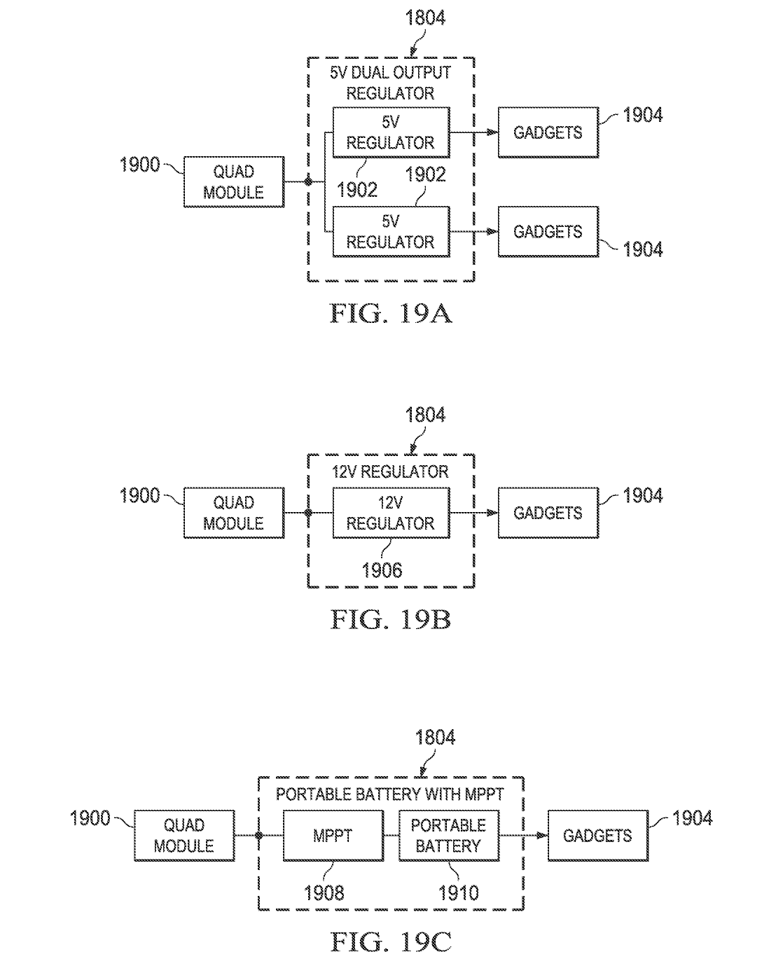

FIG. 19A illustrates the quad module 1900 attached to a voltage regulator 1804 including dual 5-volt regulator 1902 outputs to associated electronic devices 1904. FIG. 19B illustrates the quad module 1900 connected to a regulator 1804 consisting of a single 12-volt regulator 1906 powering various electronic devices 1904. In the embodiment illustrated in FIG. 19C, the quad module 1900 is connected to a configuration of a maximum power point tracking circuit 1908 connected to a portable battery 1910 charging the electronic devices 1904.

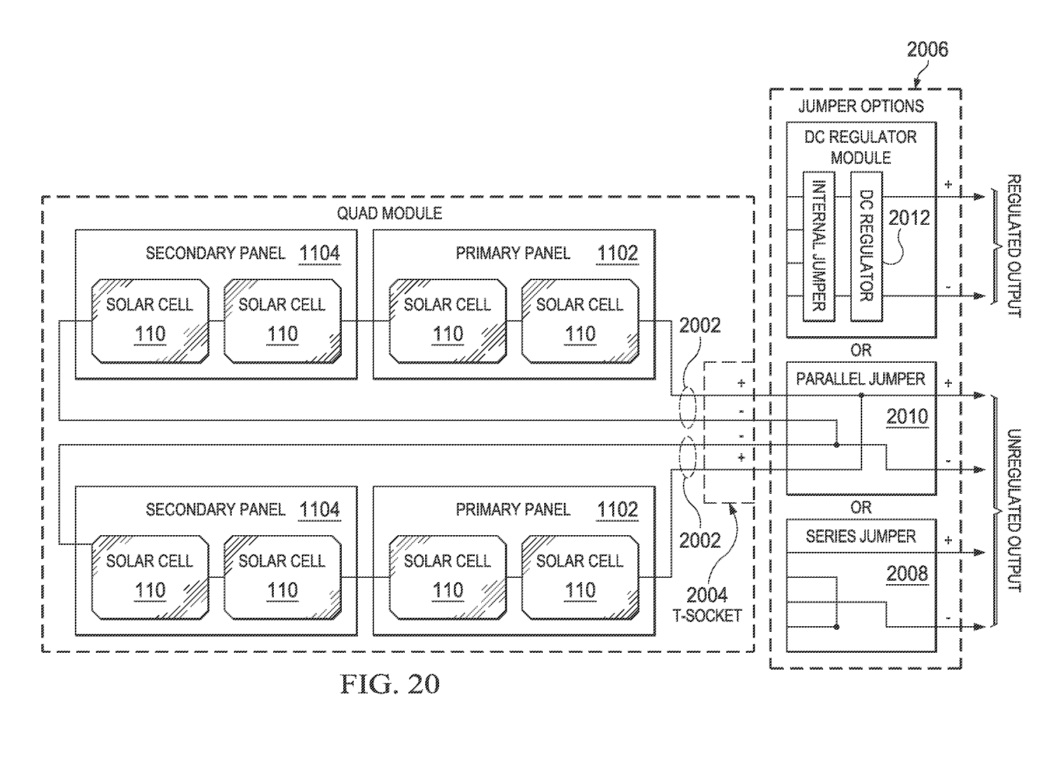

Referring now to FIG. 20, there is illustrated a more elaborate scheme for interconnecting two panel pairs wherein the output wires 2002 are terminated at an electrical terminator socket 2004. The primary panel 1102 and secondary panel 1104 are interconnected in series with each of the solar cells connected to the positive and negative terminals of the terminator socket 2004. The actual electrical interconnection between the panel pairs is determined by a separate external jumper block 2006 that mates with the terminator socket 2004 and appropriately connects the output wires from the panel pairs into either a series connection 2008 or a parallel connection 2010. Thus, the electrical configuration may be selectable by the user and the jumper block 2006 may be incorporated into a removable strap 1306 (FIG. 13) as was described earlier.

FIG. 20 also illustrates a variety of purposes for the jumper block 2006 such as producing an unregulated DC current or a varied voltages or even a regulated DC output by incorporating a DC regulator 2012 in the jumper block 2006 which output may even be connected to a portable battery. In addition, the terminator socket 2004 may be mated with a variety of external devices such as regulators, batteries or even a docking station that can hold and interconnect several quad modules together to generate a variety of electrical power outputs for a variety of applications.

Referring now to FIG. 21, there is illustrated a configuration wherein multiple quad modules 2100 are interconnected to a quad dock 2102. The power output from each of the quad modules 2100 are provided through a maximum power point tracking circuit 2104 within the quad dock 2102. The power from the quad modules may then be combined and provided to charge high capacity batteries 2106. The quad dock 2102 enables the pooling of electrical power from several quad modules for charging the high capacity batteries 2106.

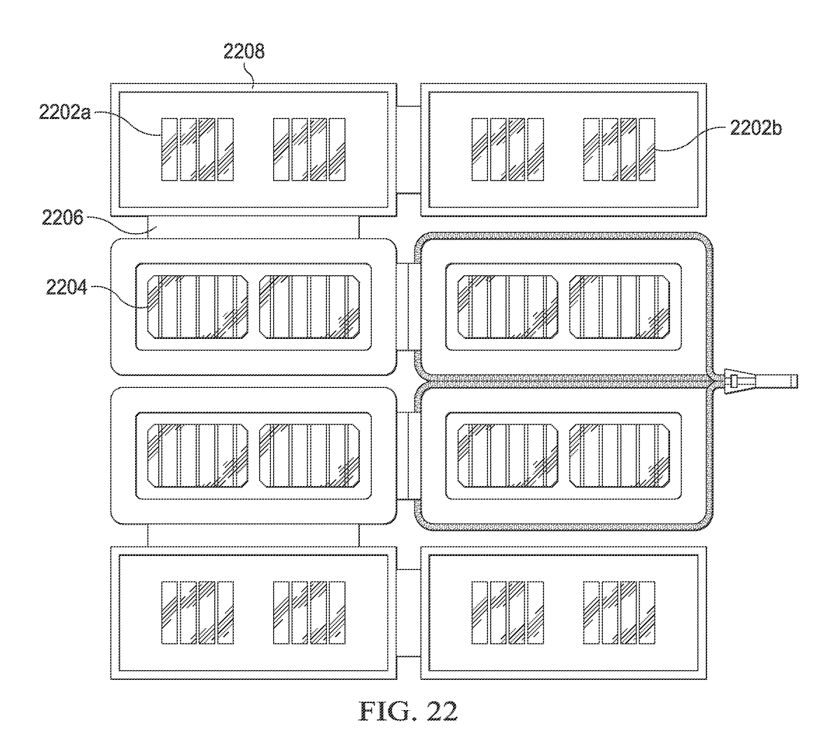

Referring now to FIG. 22, there is illustrated an example of an 8-panel pair assembly that illustrates the extendibility of the quad power modules to encompass more than 4-panel pairs and thus generate higher module power. As can be seen, the addition of further secondary panels 2202 are illustrated wherein a first secondary panel 2202a interconnects with a secondary panel 2204 via a flexible flap 2206. A further secondary panel 2202b may interconnect to secondary panel 2202a through another flexible flap 2208. Thus, the circuit maintains the initial primary panel 2210 and has more than one secondary panel extending therefrom via a series connection of flexible flaps.

It will be appreciated by those skilled in the art having the benefit of this disclosure that this portable folding photovoltaic solar charger provides an improved manner of portable electrical power generation. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A portable, solar energy charger, comprising:
a plurality of panels, each panel containing at least one solar cell for generating electrical energy responsive to solar energy, each of the plurality of panels interconnected to enable the plurality of panels to be folded on top of each other in a single stack in a closed configuration and to be unfolded to receive sunlight in an open configuration;
a connector for connecting each of the plurality of panels to at least one other panel of the plurality of panels, the connector providing both a mechanical connection and an electrical connection between panels, the connector enabling a first panel to be folded on top of a second panel and protect the at least one solar cells on the first panel and the second panel between the first panel and the second panel;
a securing mechanism for maintaining the plurality of panels together in the closed configuration when the panel are folded on each other; and
power circuitry for receiving the electrical energy from the plurality of panel and providing an electrical power output.

2. The portable, solar energy charger of claim 1, wherein the connector further comprises a flexible cable that mechanically and electrically interconnects a pair of the plurality of panels.

3. The portable, solar energy charger of claim 1, wherein the securing mechanism comprises at least one flexible flap having a first portion connected to a back side of a first panel and a second portion removeably connected to a back side of a second panel.

4. The portable, solar energy charger of claim 3, wherein the at least one flexible flap comprises:
a first flexible flap having the first portion connected to the back side of the first panel along a first edge of the first panel and the second portion removeably connected to the back side of the second panel along a first edged of the second panel;
a second flexible flap having the first portion connected to the back side of the first panel along a second edge of the first panel and the second portion removeably connected to the back side of the second panel along a second edged of the second panel;
a third flexible flap having the first portion connected to the back side of the first panel along a third edge of the first panel and the second portion removeably connected to the back side of the second panel along a third edged of the second panel;
wherein the first panel and the second panel may be placed in a first open configuration when the second portion of the first flexible flap and the third flexible flap are disconnected from the back of the second panel and the second portion of the second flexible flap is connected to the back of the second panel;
wherein the first panel and the second panel may be placed in a second open configuration when the second portion of the first flexible flap and the second flexible flap are disconnected from the back of the second panel and the second portion of the third flexible flap is connected to the back of the second panel.

5. The portable, solar energy charger of claim 1, further including a water resistant material covering the back of the plurality of panels.

6. The portable, solar energy charger of claim 1, further including:
a pocket defining an opening on the back of a first panel of the plurality of panels; and
a sealing mechanism for closing the opening defined by the pocket.

7. The portable, solar energy charger of claim 6, further including a divider for dividing the pocket into a plurality of compartments.

8. The portable, solar energy charger of claim 1 further comprising an eyelet defined at a corner of the plurality of panels.

9. The portable, solar energy charger of claim 1 further including molded plastic covering the back of the plurality of panels.

10. The portable, solar energy charger of claim 1, wherein the connector further comprise a hinged connection between a first panel and a second panel of the plurality of panels.

11. The portable, solar energy charger of claim 1, wherein the plurality of panels further comprises:
a first and second primary panels each containing at least one solar cell for generating electrical energy responsive to solar energy, the first and second primary panels selectively interconnected to enable the first and second primary panels to be folded on top of each other in a single stack in a closed configuration and to be unfolded to receive sunlight in a first open configuration and a second open configuration; and
at least one secondary panel connected to each of the first and second primary panels via a flexible flap, the at least one secondary panel containing at least one solar cell for generating electrical energy responsive to the solar energy, wherein the at least one secondary panel may be folded into a space between the first and second primary panels in the closed configuration and unfolded to receive sunlight in the first and second open configurations.

12. The portable, solar energy charger of claim 11, wherein the connector further comprises a carrying strap having an electrical connection between first and second primary panels.

13. The portable, solar energy charger of claim 1, wherein the securing mechanism further comprises a zipper surrounding edges of the first and second primary panels for selectively connecting each of the edges of the first panel to each of the edges of the second panel to enclose the at least one secondary panel between the first and second primary panels in the closed configuration, for selectively connecting a first edge of the first panel to a first edge of the second panel in the first open configuration and to connect a second edge of the first panel to a second edge of the second panel in the second open configuration.

14. The portable solar energy charger of claim 1, wherein the power circuitry further comprises:
a battery for storing the electrical energy produced by the solar cells;
a first indicator for measuring and displaying an amount of the electrical energy being generated by the solar cells; and
a second indicator for measuring and displaying a charge level of the battery.

15. A portable, solar energy charger, comprising:
a first and second panels, each panel containing at least one solar cell for generating electrical energy responsive to solar energy, the first and second panels interconnected to enable the first and second panels to be folded on top of each other in a single stack in a closed configuration and to be unfolded to receive sunlight in an open configuration;
a flexible connector for electrically and mechanically connecting the first and second panels to each other, the flexible connector enabling the first panel to be folded on top of the second panel and protect the at least one solar cells on the first panel and the second panel between the first panel and the second panel;
at least one flexible flap connected to a back side of the first panel and detachably connected to a back side of the second panel for maintaining the first and second panels together in the closed configuration when the first and second panels are folded on each other; and
power circuitry for receiving the electrical energy from the first panel and the second panel and providing an electrical power output.

16. The portable, solar energy charger of claim 15, wherein the at least one flexible flap comprises:
a first flexible flap having the first portion connected to the back side of the first panel along a first edge of the first panel and the second portion removeably connected to the back side of the second panel along a first edged of the second panel;
a second flexible flap having the first portion connected to the back side of the first panel along a second edge of the first panel and the second portion removeably connected to the back side of the second panel along a second edged of the second panel;
a third flexible flap having the first portion connected to the back side of the first panel along a third edge of the first panel and the second portion removeably connected to the back side of the second panel along a third edged of the second panel;
wherein the first panel and the second panel may be placed in a first open configuration when the second portion of the first flexible flap and the third flexible flap are disconnected from the back of the second panel and the second portion of the second flexible flap is connected to the back of the second panel;
wherein the first panel and the second panel may be placed in a second open configuration when the second portion of the first flexible flap and the second flexible flap are disconnected from the back of the second panel and the second portion of the third flexible flap is connected to the back of the second panel.

17. The portable, solar energy charger of claim 15, further including a water resistant material covering the back of the plurality of panels.

18. The portable, solar energy charger of claim 15, further including:
a pocket defining an opening on the back of a first panel of the plurality of panels; and
a sealing mechanism for closing the opening defined by the pocket.

19. The portable, solar energy charger of claim 18, further including a divider for dividing the pocket into a plurality of compartments.

20. The portable, solar energy charger of claim 15 further comprising an eyelet defined at a corner of the plurality of panels.

21. The portable, solar energy charger of claim 15 further including molded plastic covering the back of the plurality of panels.

22. A portable, solar energy charger, comprising:
a first and second primary panels each containing at least one solar cell for generating electrical energy responsive to solar energy, the first and second primary panels selectively interconnected to enable the first and second primary panels to be folded on top of each other in a single stack in a closed configuration and to be unfolded to receive sunlight in a first open configuration and a second open configuration;
at least one secondary panel connected to each of the first and second primary panels via a flexible flap, the at least one secondary panel containing at least one solar cell for generating electrical energy responsive to solar energy, wherein the at least one secondary panel may be folded into a space between the first and second primary panels in the closed configuration and unfolded to receive sunlight in the first and second open configurations;
a zipper surrounding edges of the first and second primary panels for selectively connecting each of the edges of the first panel to each of the edges of the second panel to enclose the at least one secondary panel between the first and second primary panels in the closed configuration, for selectively connecting a first edge of the first panel to a first edge of the second panel in the first open configuration and to connect a second edge of the first panel to a second edge of the second panel in the second open; and
power circuitry for receiving the electrical energy from the plurality of panel and providing an electrical power output.

23. The portable, solar energy charger of claim 22, further comprising a carrying strap having an electrical connection between first and second primary panels.

24. The portable solar energy charger of claim 22, wherein the power circuitry further comprises:
a battery for storing the electrical energy produced by the solar cells;
a first indicator for measuring and displaying an amount of the electrical energy being generated by the solar cells; and
a second indication for measuring and displaying a charge level of the battery.

25. The portable, solar energy charger of claim 22, further including a water resistant material covering the back of the first and second primary panels.

26. The portable, solar energy charger of claim 22, further comprising at least one further secondary panel connected to each of the at least one secondary panels via a flexible connector.

27. The portable, solar energy charger of claim 22, wherein the power circuitry further includes a jumper connector interconnecting the primary panels with a power output, the jumper connector providing at least two of a parallel connection, a series connection and DC regulated module between the primary panels and the power output.
